(19) United States
(12) Patent Application Publication
(10) Pub. No.: US 2007/0087843 A1
(43) Pub. Date: Apr. 19, 2007

(54) Game phase detector

(76) Inventors: Rolland N. Steil, Las Vegas, NV (US); Clyde Ruckle, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/515,361

(22) Filed: Sep. 1, 2006

Related U.S. Application Data
(60) Provisional application No. 60/715,629, filed on Sep. 9, 2005.

(51) Int. Cl. G06F 19/00

(52) U.S. Cl. 463/47; 463/46

(57) ABSTRACT

A game phase detector for detecting or receiving input regarding different phases of a wagering game and providing a game phase output to a table monitoring system. The game phase detector may have a switch, optical signal detector, or other interface capable of detecting or receiving a card or user input. The output of the game phase detector is processed by a table monitoring system, such as an RFID table monitoring system. Game phase data correlates table monitoring system data to accurately monitor game play and wagers. In the game of blackjack, the game phase detector may comprise a dealer hole card detector configured to detect the presence or rank of a dealer hole card.

### PRIORITY CLAIM

This application claim priority to provisional patent application Ser. No. 60,715,629 filed Sep. 9, 2005.

### FIELD OF THE INVENTION

The invention relates to hold card sensors or detectors and in particular to a method and apparatus for detecting status of a dealer's hand

### BACKGROUND

Within casinos and other gaming establishments, table games provide a popular and traditional form of wagering. While the games themselves have remained unchanged over the years, there are numerous different advancements which have occurred to improve the player's experience and prevent fraud or cheating. These advances include comfortable seating and tables to improve player comfort and extend potential playing time. Other advances include overhead camera monitoring and radio frequency identification of players or tokens which improve accounting and discourage dishonesty.

These advances have generally improved overall game play, but such advances may generate additional hurdles and drawbacks. For example, RFID table monitoring system have the capability to greatly improve the gaming experience, but current RFID system configurations may not be able to gain the full potential of the RFID system operation.

It is also contemplated that casinos or gaming establishments may require additional information regarding game play. This additional information may be used to track game play, for security purposes, or for any other reasons as may be contemplated by the casino or gaming establishment. One drawback to current systems is that such systems are limited in the amount and type of information regarding the wagering event which may be generated. As a result, there is a need in the art for additional systems which can provide additional information regarding game play.

### SUMMARY

A game phase detector for detecting or receiving input regarding different phases of a wagering game is disclosed. The game phase detector outputs data regarding the phase of the game to a table monitoring system. The game phase detector may have a switch, optical signal detector, or other interface capable of detecting or receiving a card or user input that indicates one or more aspects or phases of the game. The output of the game phase detector is processed by a table monitoring system, such as an RFID table monitoring system. Game phase data correlates table monitoring system data to accurately monitor game play and wagers. A time/date stamp may also occur. In the game of blackjack, the game phase detector may comprise a dealer hole card detector configured to detect the presence or rank of a dealer hole card.

In one embodiment a game status detector is disclosed which includes a housing configured to accept one or more playing cards and a signal generator configured to direct a signal into the housing. A signal detector is also provided which is configured to detect the signal when a playing card is not within the housing and not detect the signal when the playing card is within the housing, the signal being blocked by the playing card. The detector also generates a game status output representing whether a card is, or is not, within the housing. Also part of this system is a radio frequency table monitoring system configured to receive and process the game status output to synchronize game status with data received from one or more radio frequency signal monitors associated with the table.

In one embodiment the detector further comprising a visual or audio indicator that will prompt the dealer and players that the dealer may or may not have a blackjack winning hand. For example, the game status output may indicate the status of a game of blackjack and the game status output differentiates between a player decision round and a dealer round during a game.

In one embodiment the signal comprise an optic signal and the game status output is processed by the radio frequency table monitoring system to determine one or more of the following: start of a new game, end of dealing round, end of a betting round, or beginning of a dealer round.

Also disclosed herein is a method for detecting one or more phases in a card game. In this example method, the system accepts one or more wagers and dealing one or more cards to one or more players and dealing one or more cards to a dealer, such that each card dealt to the dealer comprises a dealer card. The method also places one or more dealer cards in a detector and generates or eliminates a first detector signal in response to one or more dealer cards being placed in the detector. Then, the system accepts one or more wagers from one or more players and deals one or more cards to one or more players. Thereafter, this method removes one or more dealer cards from the detector and generates or eliminates a second detector signal in response to one or more dealer cards being removed from the detector. The dealer may then deal one or more cards to the dealer.

In one embodiment this method may further comprise receiving the first detector signal and the second detector signal at a table monitoring system, such that the table monitoring system is configured to monitor one or more wagers placed by one or more players, one or more cards dealt to the one or more players and to the dealer, or both. It is contemplated that the table monitoring system may comprise a radio frequency identification system configured to monitor one or more wagers using radio frequency signals. In addition, the method may further comprise processing the first detector signal and the second detector signal with the table monitoring system to differentiate between phases in the card game. It is further contemplated that first detector signal and the second detector signal may be processed by the table monitoring system to determine when wagering by the players is not allowed.

The actual monitor itself may comprise any number of different devices. In one embodiment generating or eliminating a first detector signal comprises actuating a mechanical switch which in turn generates the first detector signal or eliminates the first detector signal.

Also disclosed herein is a game monitor for detecting and reporting one or more phases of a game to a wager monitoring system. In this embodiment the game monitor comprises a signal generator configured to generate a detector signal and a user interface configured to receive the detector signal to thereby detect one or more playing cards or a user input. An output path from the user interface is configured to convey the detector signal or a user interface output signal to a wager monitoring system. A wager monitoring system is provided configured to receive and process the detector signal or a user interface output signal to thereby record one or more phases of a game based on the detector signal or a user interface output signal.

In one embodiment the wager monitoring system is further configured with one or more radio frequency identification antennas which are configured to transmit and receive a radio frequency signal. It is contemplated that the user interface may comprise a playing card detector configured to receive one or more cards. The user interface may comprise a mechanical switch or other type detector. For example, the signal generator may comprise a signal generator selected from the group of signal generators consisting of a voltage or current source, an optic signal generator, and electromagnetic signal generator. As part of this or other embodiments is a time stamp module configured to generator or associate a time stamp with the detector signal or a user interface output signal. It is contemplated that the detector signal or a user interface output signal may provide information regarding the rank of a card.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating a top plan view of a gaming table with table monitoring capability.

FIG. 2 is a block diagram illustrating the table monitoring system.

FIG. 3 illustrates an example embodiment of a card detector or dealer hand status detector.

FIGS. 4A-4C illustrate an exemplary operational flow diagram of one example method of operation.

### DETAILED DESCRIPTION

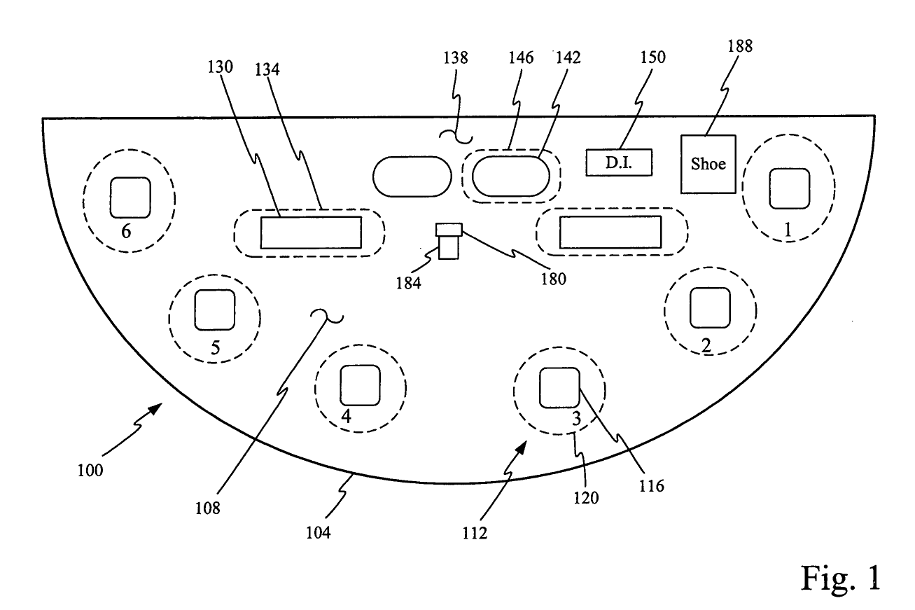

FIG. 1 illustrates a top plan view of an example embodiment of a gaming table for use with a table game. This is but one possible table arrangement and layout, and it is contemplated that one of ordinary skill in the art may arrive at other table arrangements to promote game play or accommodate a greater or fewer number of players. For example, it is contemplated that the method and apparatus described herein may be utilized with any game layout. Likewise, the table can be configured in a stand-up or sit down arrangement. In this example embodiment, the table is configured for use with a table monitoring system.

In this example embodiment the table 100 includes an outer edge 104 surrounding a generally flat top surface 108. The table 100 may also be configured to accommodate other types of traditional table games including, but not limited to, dice games such as a modified form of craps, poker, baccarat, or non-proprietary table games such as roulette, and other games which use dice, wheels, or cards or any combination of dice, wheels, or cards. Table games include games of chance that use cards or dice, and tokens, such as chips of differing values. Traditional table games also include proprietary games such as Caribbean Stud Poker® which include a progressive jackpot. Other proprietary traditional table games include games such as Three Card Poker®, Royal Match 21® and Texas Hold'em Bonus™. Proprietary table games are table games for which a casino will lease or purchase from a manufacturer because the proprietary traditional table game is protected by the intellectual property of the manufacturer. The term “traditional table game” is used to distinguish from products offered by TableMAX® and Digideal's Digital 21™ which use video representations of cards. There are other non-traditional table games that have digital roulette wheels with video or digital images of dealers.

In this example embodiment of a table, configured for use with the game of black jack, there is an outer edge 104 of the table 100. One or more player stations 112 are provided and configured for use by a player to participate in a waging game or a game of chance offered at the table such as blackjack. In this embodiment the player stations 112 comprise a bet spot 116 wherein a player may place one or more wagers during the course of play. For example, the player may place the chips or tokens within area 116 when placing a bet during the course of play. Overlapping the bet spot 116 is a detection zone 120. The detection zone 120 comprises a zone within which a bet detection system, described below, may detect the token, such as an amount bet by a player at a player location 112 or player station at the table 100. Likewise, other data stored on the token may also be detected by the bet detection system.

In other various embodiments, one or more supplemental bet spots may be located in one or more other locations on the table surface 108. By way of example, a supplemental bet spot 130 may be located as shown and shared by more than one player. A supplemental detection zone 134 may likewise be associated with the supplemental bet spot 130 to detect a bet therein. The supplement bet spots may also comprise token buy-in spots that have detection capability to detect player's buy-in. A supplemental detection zone could also be added to detect multiple bets that are required or optional by a player in proprietary table games such as Caribbean Stud Poker®, Three Card Poker®, Royal Match 21®, Texas Hold'em Bonus™, and Two Card Joker Poker™.

In this example embodiment a dealer position 138 is located generally opposite one or more of the player positions. As is generally understood, the dealer presents the game from the dealer station 138. Associated with the dealer station 138 are one or more dealer spots 142 which in turn may be associated with one or more dealer detection zones. The dealer spot 142 is a location on or in some way associated with the table and/or the dealer on which tokens may be placed for detection by the detection system. As used herein, the term token may refer to a DID type token that is detectable by the table monitoring system. One example of such a token available from Gaming Partners International and a system that is available from Progressive Gaming International Corporation located in Las Vegas, Nev.

The dealer detection zone 146 is the area in which the detection system can detect tokens placed in the dealer spot 142. This dealer detection zone 146 could be used in player banked traditional table games such as those played in the State of California or other jurisdictions. The dealer detection zone 146 may also be used to hold ante bets contributed by players in Class II gaming jurisdictions such as Native American gaming establishments in the State of Florida.

Also associated with the dealer position 138 is a hole card detector 180 configured to accept one or more cards 184. The hole card detector 180 may also be referred to or considered as a dealer status detector because the output from the detector may be utilized to determine the status of the game or dealers hand. The hole card detector 138 is described below in more detail. It is contemplated that during play, the dealer, after receiving one or more of their cards, will place one or more of the cards into the hold card detector 180. In response, the hold card detector will send or modify a signal, to a table monitoring system. In one embodiment the hold card detector 180 indicated to the table monitoring system when the dealer's card(s) are in the detector.

A smart shoe type card dealing shoe 188 or shuffler may be associated with the table to assist in or perform the dealing of cards. In the example embodiment of FIG. 1, the smart shoe is shown as element 188 but in other embodiments other card detectors may be utilized. It is contemplated that the smart shoe 188 may be configured in any manner to accurately detect which cards (suit and rank, or rank only) are dealt to the players, or a particular player, and which cards are dealt to the dealer. The detection may occur generally, such as rank, or specifically, with rank and suit. It is contemplated that the shoe 188 may comprise a shuffler that tracks cards, a shoe, a card detector, a monitor, or any other card tracking/monitoring device that is capable of determining which cards are provided to or possessed by the players(s) and the dealer. The smart shoe may output or provide this data to the table monitoring system, such as a computer or software executing on the computer, or any other device or element.

A dealer interface 150 may also be place near the dealer position 138. The dealer interface 150 comprises a user interface configured to allow the dealer to provide input to the detection system and optionally receive input from the detection system. In various embodiments, the dealer interface 150 comprises one or more buttons, dials, display screens, lights or other illumination devices, speakers or other audible indicators, or analog dials, potentiometers, or keypads. Through use of the dealer interface 150, the dealer is able to provide input to the detection system or receive data from the detection system.

Table Monitoring System

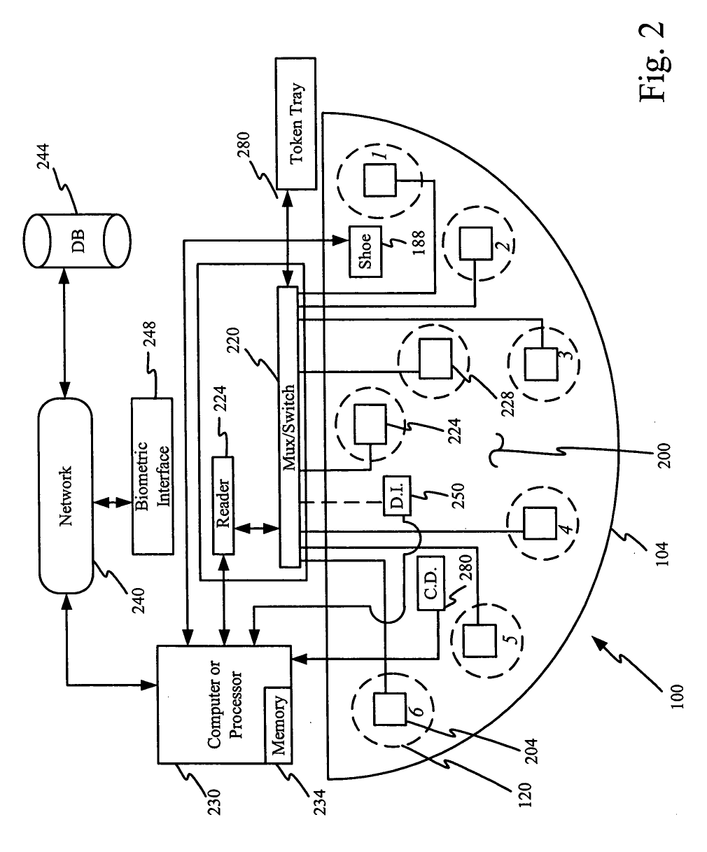

FIG. 2 illustrates a block diagram of the detection system in connection with a game table. This is but one possible example configuration and the elements as shown are for purposes of discussion and hence are not to scale. As part of the table 100, there is an underside 200 of the table, which is shown in FIG. 2. As way of reference, the outer surface 104 and player positions 1-6 are shown. A DID antenna 204 may be mounted below the table 100, be integral with the table, or on the top of the table. In this embodiment the DID antenna 204 is below or on the underside 200 of the table and creates a detection zone 120 when so instructed by the detection system described above. The detection zone 120 may also be understood as the area in which the energy emitted by the antenna energizes the DID detectable identification of the token. In one embodiment the DID token includes an radio frequency tag or an RFID element.

The DID antenna 204 connects to a multiplexer, diplexer, or switch 220, which in this embodiment controls communication between a reader 224 and the antenna 204. It is contemplated that communication between the reader 224 and the one or more antenna 204 is bi-directional such that the reader may provide an electrical excitation signal to the antenna 204. The antenna 204 converts the electrical signal to an electromagnetic field (EMF), which excites or powers the DID aspects of the token located within the detection zone. As a result and in response to the excitation EMF signal, the antenna may also detect data emitted from the DID device. The data is sent back, via the multiplexer 220, to the reader 224.

A token tray 280 may also be provided that reads and/or writes to any token within the tray, reports newly incoming tokens and outgoing tokens. This provides the monitoring system with data regarding the tokens purchased by or paid out to players and tokens collected from players. This allows the system to further track incoming and outgoing tokens. Tokens purchased by a player and not passing through the token tray 280, i.e. won or cashed in, may be assumed to have left with or been kept by the player. Tokens presented for play on the table that do not pass through the token tray 280 may be assumed to have been brought to the table by the player.

In one embodiment, the electronic readable token tray can provide token inventory information within any four wall casino or multi site casinos and managed by any software that is separate or part of the full player tracking system that in turn will provide, at a moments notice, the entire banked token inventory, each token tray inventory, floating token inventory (tokens not in play and not in the bank), and notification when a de-issued token has been received or played.

Operation of the other DID antenna associated with the other player stations occurs as described above. A dealer DID antenna 224 is also provided with the associated detection zone. One or more secondary bet or token spot antenna 228 with associated detection zone is also provided as shown. These elements 224, 228 also connect to the multiplexer/switch 220. Hence, the reader 224 may selectively read the DID information contained within the tokens placed at the bet spots as shown in FIG. 1 during the course of game play. A device other than a multiplexer may be used to concurrently energize more than one antenna to speed the read process. A dealer interface 250 also connects to a monitoring system, such as to a computer 230, or via the multiplexer 220 to thereby provide input to the computer 230, such as shuffle and new game data, place bets data, no bets accepted data or any other indication signals. The detection system on the computer 230 may also detect if bets are made or changed at times that are not allowed.

The reader 224 connects to any type processor which may be embodied in a computer 230 having memory 234. The computer is configured to execute machine readable code which may be stored on the memory 234. The machine readable code may comprise software code or code logic capable of interaction with other systems, such as the reader. The computer 230 may include an input interface for receiving input from a user such as pit supervisory personnel or dealer, such as a keyboard, analog dial, potentiometer, mouse, touch screen, or any other device capable of providing information to the computer. The computer 230 may also be configured with one or more displays. The computer 230 will allow the input of information by pit supervisory personnel and/or a dealer.

Also associated with the dealer station is a card detector 280 which was also referenced above as detector 180. In this embodiment the detector communicates with the computer 230 or any other device to provide data regarding the hole card, the presence of the hole card, or both, to the detection system, which is shown in FIG. 2. The term hold card is defined herein to mean any one or more cards of the dealer's which may or may not be visible to any player or dealer during the dealing and player decision rounds.

In one embodiment the output of the card detector 280 may comprise a basic digital signal, such as a positive voltage and a zero voltage value to represent the presence of a card in the detector. In another embodiment, a more sophisticated detector may be used to interrogate the card, in any manner now known or developed in the future, to indicate the presence of an ace card, 10 value card, or the lack of any of these type cards in the detector. In one embodiment the detector 280 may comprise or include a camera, either video or still photo, configured to capture an image of the card that is in the detector. Determining the type of card to any degree of accuracy, such as rank, suit, or other factors, may be performed in any manner known in the art.

As discussed above and shown as element 188, the smart shoe may provide one or more outputs to the computer 230 associated with the table monitoring system. This may allow the table monitoring system to determine the cards that comprise the dealer hand and/or player hands.

In the embodiment shown in FIG. 2, the computer 230 connects to a network 240 which in turn may connect to a database 244 and/or a biometric interface 248. A database 244 is generally understood in the art as an accessible memory for storing accessible data. The network 240 may include access by surveillance personnel in the casino.

The biometric interface 248 comprises any type system configured to monitor and identify players based on one or more player characteristics. In one such configuration a camera is capable of capturing a player's picture, such as of their face, and the biometric system compares the player's picture to a data base of known dishonest players or banned individuals. The biometric system 248 in connection with the bet detection system may be utilized to monitor for and identify certain players who may be attempting to gain an unfair advantage. One exemplary biometric system is available from Biometrica Systems, Inc in Las Vegas, Nev.

It is also contemplated that the computer 230 and the network 240 may be equipped to send and receive e-mail or other forms of electronic output. In one embodiment, the detection system, such as the computer 230, the network 240, or a mail server associated with the network, may be controlled to send e-mail, voice messages, or other notification to a party to alert or notify them of information generated by the detection system.

Table Monitoring Operation

In operation, the system shown in FIG. 2 operates to monitor one or more of the following, tokens on the table, cards dealt, and the status of the dealers cards, such as the location of the dealers cards in the card detector. Numerous different aspects or methods of monitoring the tokens on the table are possible.

When the tokens are monitored or detected, in the various manners described below, the token information may be provided to the computer, processed in the manner described below, and output to a dealer, pit supervisory personnel, surveillance, casino hosts, or other third party. In one embodiment the processing may occur at the table itself such as with a controller or control logic, and not at the computer.

The bet detection system may be configured in any desired manner, such as described below. In general, the detection system detects tokens on the table. In one embodiment the detection system is configured to detect players attempting to obtain an unfair advantage by adjusting their bets during periods in which bet alteration is prohibited. In other embodiments, as discussed herein, the detection system may be utilized for other monitoring and reporting functions.

Although operation of a gaming table is generally understood, a brief description is provided with focus on operation of the detection system as shown in FIG. 1 and FIG. 2 and reference to other figures occurs to aid in understanding. After shuffling of one or more decks of cards by hand or through an optional automatic card shuffler, to insure fair and random game play, the dealer may optionally press the shuffle button 208 of the dealer interface 150 to notify the detection system that dealing will occur from a newly shuffled deck or decks of cards dealt by hand or by a shoe. Likewise, to indicate the start of a new game, the dealer may press the game start button 216 to indicate the beginning of a new game. In the game of blackjack, a game ends after: (1) All players cease taking additional cards either by choice or by receiving a total of 21 or higher; and (2) The dealer receives a total of 21 or higher or stops taking additional cards according to preset rules. It is anticipated in the game of blackjack that there may be more than one game before a shuffle is necessary, although shuffle may occur every game. Other games will operate under different rules than blackjack. Alternatively, the use of the shuffle button may also indicate the beginning of a new game, but only a new game after a shuffle.

In general, the dealer may then accept wagers, deal the cards to the players and conduct the game as would be understood. When a player places a bet at a player bet spot, one or more detectors detect placement of the token placed within the detection zone. The detector provides this information to the detection system. After a round of betting is complete, the dealer may press the bets complete button on the interface to signal that the betting period is closed. The dealing may be performed in connection with a smart shoe 188 and the dealer actions may be coordinated with the card detector 180.

During the play of a game such as blackjack, supplemental bets such as double down, splitting and insurance by the player may be allowed by the game rules and thus can be detected by the detection system as valid betting. The supplemental bets can be detected by the detection system either by human intervention by using the dealer console or by game analysis software that monitors playing cards, or other indicia, and betting data in real time and thus verify that the player has right to add supplemental bets against the rules of the particular game being played and monitored by the detection system. After completion of the game, the dealer may pay winning hands including any supplemental bets and the payouts given to each winning player may optionally be detected to verify correctness in pay. The dealer interface may be used as part of this process. Prior to the start of a new game, i.e. dealing of the cards, the dealer may press the game start button to indicate to the detection system the start of a new game, and hence a new round of betting is ready for detection by the detection system. Other input may be provided to the dealer interface or via other components of the detection system.

Bet Tracking

In one embodiment, the detection system operates to detect wagers by a player. The detection system, configured as described above, detects a wager by a player, such as during a first round of betting. The detection system may also detect supplemental bets by the player. Operating in this manner, the total amount bet by a player may be monitored and tracked.

Bets may be associated with a player in any manner. In one embodiment the tag or id of the DID token is associated with the player when the player purchases or obtains the tokens. In another embodiment the position at which the bet is placed is attributed to the player. It is contemplated that the detection system associated with a table polls the table sufficiently rapidly to detect supplemental bets. In one embodiment the table is polled once every two seconds. In one embodiment the detection system polls the table once every second. In one embodiment the detection system polls the table multiple times per second. The term polls the table is defined to mean reading one or more tokens in one or more detection zones.

Bet tracking to associate and accurately recognize the amount bet by a player provides the advantage of accurately tracking a player's total amount bet over time or at a particular point in time. This data can be used for numerous purposes. Bet amount tracking data may be used to more accurately compensate players deserving of compensation, such as with free rooms or meals. Another reason to accurately track bet amounts is to focus appropriate marketing or advertising efforts on the appropriate players that are more likely to play more and thus increase the casino's profits over time.

One advantage over prior art systems that attempted to track wager amounts using bet detection, the method and apparatus described herein is highly accurate, such as compared to overhead cameras or table optical sensors, and is capable of detecting chips which may have multiple stacks of tokens. This is a particular advantage where each stack can contain multiple tokens and where tokens of one likeness may be hidden or optically blocked by other tokens of another likeness, such as used in Roulette where multiple colors are used and each color on the table represents individual bettors or players. Likewise, the present invention is capable of detecting supplemental bets, such as but not limited to double down, splits or insurance in blackjack. Consecutive polling of the table within the time frames set forth herein by the detection system provides the benefit of detecting tokens during regular game play. By consecutively and continuously polling all bet detection zones within a table during the framing of a game round (the period between game begin signal and game end signal), the bet detection system can monitor and store the differences against the initial bet placed by the player in a near real time period. Monitoring the bets in real time or close thereto, the detection system can decide, based on game rules, that the differences in bets on each position or by differentiating color codes is either valid and allowed by the game rules or that the player may be cheating by adding or subtracting bets when the game is in favor or out of favor for winning that hand in the game round. In the case of bets being changed that do not follow the rules of the game, the bet detection system can then be set to alert casino personnel of possible illegal actions by the player. When comparing a real time system against a system that is capable of reading all tokens in all bet zones every few seconds (slower than real time) during a game round, the bet differences may not be able to be detected fast enough to allow the detection system to flag undesirable actions by a player of the game.

In addition to bet monitoring, the smart shoe may monitor one or more cards dealt by the dealer to the players and the dealer. In one embodiment the table monitoring system is aware or provided data regarding the cards possessed by each player and the dealer.

Hole Card Detector—Game Phase Detector

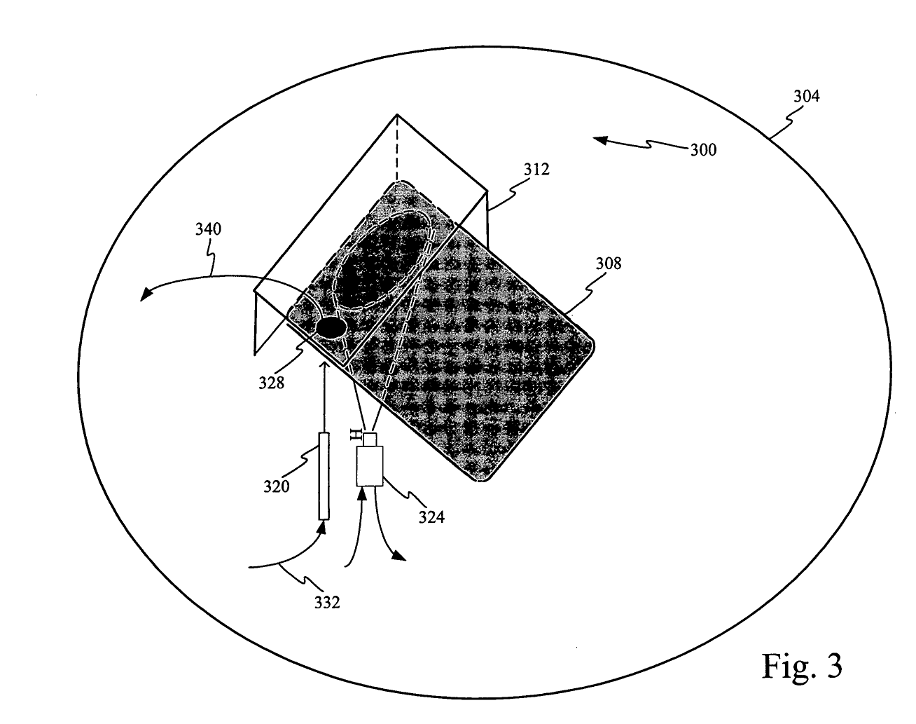

FIG. 3 illustrates a block diagram of an example embodiment of a hold card detector. In one embodiment, the hold card detector 300 is configured to operate as a dealer hand status detector. In this example configuration the detector 300 may be located on a table 304 or other surface. In one configuration the detector 300 has a housing 312 which may have an opening configured to accept one or more cards 308. The cards may be placed in the detector 300 in any orientation. In one configuration the cards are placed in the detector face down.

In embodiment the detector further comprises a signal source 320, a camera 324, or both. In one embodiment the signal source 320 comprises a light source configured to direct a signal to a detector 328, which may be positioned opposite the source. In this embodiment the signal source 320 received an input on path 332. The input may comprise a power signal, or a data signal to create a time varying signal. The detector 328 may provide its output on path 340. The output may comprises a signal representing whether or not it is receiving the light signal, to the computer 230 (FIG. 2) or other element of the monitoring device.

In one embodiment the light source 320 is located below the table and hence shines up through the table to the light detector 340 when a card is not in the detector. In one embodiment, the hole card detector 300 is configured as an integral or self contained unit whereby the source 320 is contained within the hole card detector housing 312. It is contemplated that the location of the source 320 and the detector 340 may be reversed. It is contemplated that a signal source 320 may be utilized that does not generate visible light energy. By way of example and not limitation, the signal source may emit a non-visible light signal, such as infrared or ultraviolet, high or low frequency energy, or an ultra sonic signal, or any other type of signal or energy.

This example embodiment optionally includes the camera 324 configured to read the downward facing face of the card and generate signal which is output to the table monitoring system. Any type camera 324 may be used. A still or video camera may be used. The image processing capability, used to detect the type of card, may be part of the card detector 300 or such processing may occur on a computer associated with the table monitoring system.

It is contemplate that in addition to the features understood to be provided by a camera, the camera's output signal may detect the presence of a card 308 in the detector 300. The camera may be configured to detect the exact type of card 308 or whether or not the card is an ace, a ten, or both or neither.

In one embodiment the detector 300 may be configured with a mechanical switch configured complete or open an electrical circuit when a card is inserted into the detector. Upon remove the card, the switch would in turn be actuated to an alternate position to thereby change the characteristic of the electrical circuit, such as from an open state to a closed state, or vise versa. Appropriate logic may be included with or in some way associated with the detector 300 or table monitoring system to interpret the states of the detector.

In other embodiments it is contemplated that the card detector 300 may be configured with any type card detector or monitor capable of outputting a signal representing the presence of a card in the detector or the status of the dealer's hand. By way of example, when a dealer receives their hand from the shoe, the card(s) may be placed into the card detector.

The card detector described herein may be used in any game. In the game of blackjack, the placement of the card into the detector indicates the end of the dealing round or dealing phase and the beginning of the player decision round. The card detector 300 would provide a signal to the table monitoring system when the cards are placed into the card detector. Conversely, when the dealer removes their cards from the card detector 300 it signifies the end of the player decision round and the beginning of the dealer round.

Other games that use wheels or dice or any other gaming piece that may not comprise of cards can use a device to indicate the end and/or beginning of various game playing phase. One example in roulette the system would use a toggle switch that is attached to the computer that would then send a signal to the game monitoring system each time the dealer toggles or actives that switch to indicate that no more betting is allowed. Once the toggle switch is back to the inactive state, the game monitoring system would then detect the end of the final phase of the game of roulette.

Example Method of Operation

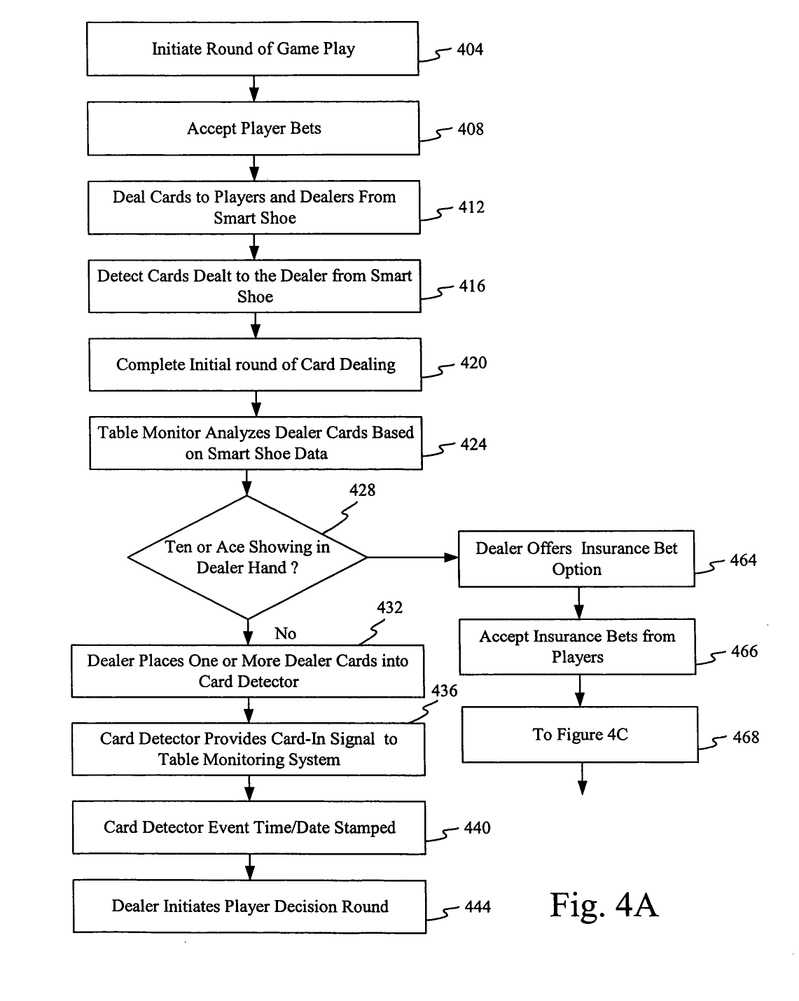

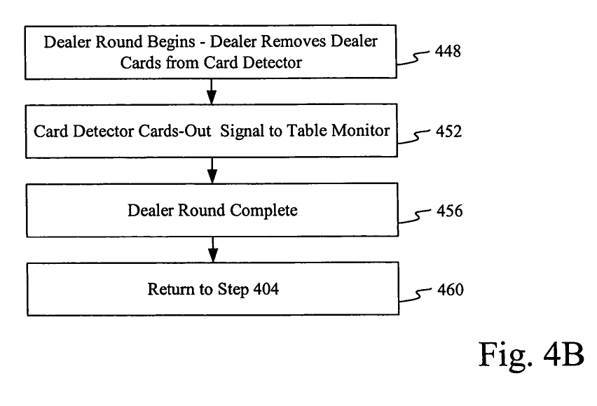

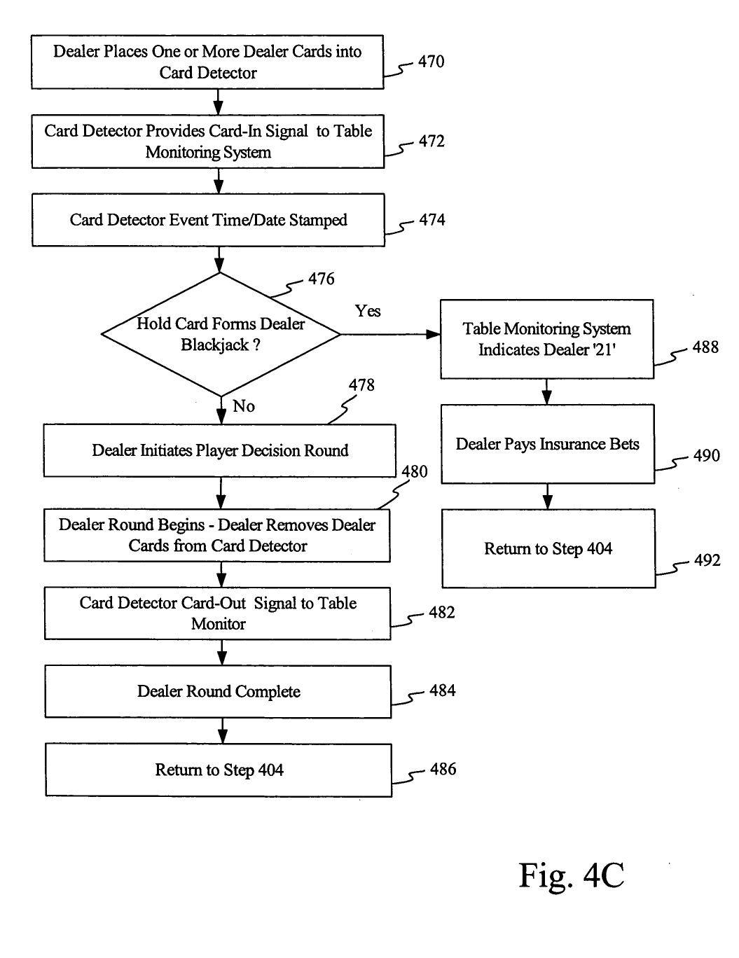

FIG. 4 illustrates an operational flow diagram of an example method of operation in connection with the game of blackjack. In other configurations or when used with other games, other methods of operation may result. At a step 404, a round of play is initiated and the elements to achieve play, as described or suggested herein, are provided. At a step 408 the dealer accepts bets from the one or more players. In the event a bet monitoring system is utilized, the bets, from a player, are detected when placed on the table.

Thereafter, at a step 412 a dealer deals the cards to the players and the dealer to form the player hands and the dealer hands. As used herein the term players and player may be used interchangeably. Any number of player hands and dealer hands may be dealt. It is contemplated that in this embodiment the cards are dealt by a smart shoe type device and in conjunction with the computer 230 running the game monitoring system, they are capable of and being configured to detect which card is dealt to each player and which cards are dealt to the dealer. In one embodiment the following type of shoe may be utilized: an image based recognition card shoe produced which may be available from Shuffle Master, Inc.

It is contemplated that the smart shoe will provide the card/player association data (which cards are in the player's hands and dealer's hand) to the table monitoring system. This occurs at step 416 wherein the shoe detects which cards are in the dealer's hand. At this stage, the monitoring system is aware cards are being dealt from the shoe and that there are not any cards in the card detector. At step 420, the dealer completes the initial round of card dealing.

At a step 424, the table monitor analyzes the cards that are in the dealer's hand. In one embodiment the order in which the cards are dealt to the dealer is recorded by the smart shoe and provided to the table monitoring system. It is also contemplated that the dealer may expose their top card or bottom card in a consistent manner over multiple hands such that the consistent method of dealer behavior and play by the dealer and the table monitoring system. This results in the table monitoring system knowing which card is exposed to the player and which card is maintained face down by the dealer.

At a decision step 428 the dealer views the exposed card and determines if a ten or ace card is showing. In the event that ten or ace card is showing in the dealer hand, the rules may required the dealer to offer insurance wagering opportunity to the players. Insurance bets are generally understood and as such, are not discussed in detail herein.

If at decision step 428 the dealers exposed card is not a ten or ace card, then the operation advances to step 432 wherein the dealer places one or more of the dealer cards into the card detector. As a result of the cards being placed in the detector, the detector generates and provides a card-in signal to the table monitoring system. This occurs at a step 436. The card-in signal indicates to the table monitoring system that the dealer's cards are in the detector. The table monitoring system may be programmed to understand the card-in signal to indicated that the dealing round is over and that a player decision round or phase of the game is beginning. In one embodiment the dealer only places the one or more dealer cards into the card detector at this stage of the game.

At a step 440, the card detector, table monitoring system, or both time and date stamp the signal provided from the detector. As a result, the time and date of the card in signal is recorded and this may be used to track and order events on the table. Accordingly, at a step 444, the dealer initiates the player decision round of the game. In this example embodiment, the player decision round comprises the round after dealing of the cards when the players may elect to receive additional cards or place double-down bets. The player decision round ends after the players have received all requested cards and card dealing to the players is complete, i.e. just before the dealer may received cards based on the rules of play. During the player decision round, certain events may or may not occur during the player round, such as betting, or other events.

Moving now to FIG. 4B, at a step 448, the dealer round begins and at the beginning of the dealer round, the dealer removes the dealer card(s) from the card detector. As a result, at a step 452 the card detector generates and provides a card-out signal to the table monitoring system. By indicating that the dealer has removed the cards, the detector provides an optionally time and date stamped card-out signal to the table monitoring system thereby indicating the end of the player decision round and the beginning of a dealer round. In this embodiment, the dealer round comprises a round wherein the dealer may receive cards in accordance with the rules of play. This information may be useful to the table monitoring system. For example, during the dealer round players may not alter amounts bet. After the dealer has received their cards from the shoe, the dealer may collect losing bets, pay winning bets, and collect the player cards. At a step 456, the dealer round portion of the game is complete. At a step 460 the operation returns to step 404.

Alternatively, if at decision step 428 the dealers views or the system determines that the exposed card in the dealer hand is a ten or ace card, then the potential exists for the dealer have a blackjack hand. Consequently, the dealer, depending on the rules of play, may have to provide an opportunity for insurance bets. It is contemplated that the table monitoring system, due to the use of a smart shoe, is aware of the dealer cards and hence already knows if the dealer has a blackjack hand, but this is not revealed to the players until after insurance bets are placed. According, at step 464, the dealer offers the insurance bet option to the players. At step 466 the dealer accepts insurance bets. Step 468 advances to FIG. 4C.

At a step 470 of Figure C, the dealer places one or more dealer cards into the card detector. As a result of the cards being placed in the detector, the detector generates and provides a card-in signal to the table monitoring system. This occurs at a step 472. The card-in signal indicates to the table monitoring system that one or more dealer's cards are in the detector. The table monitoring system may be programmed to understand the card-in signal to indicated that the dealing phase or round is over and that a player decision round or phase of the game is beginning. In one embodiment the dealer places the one or more dealer cards into the card detector at only this stage of the game.

At a step 474, the card detector, table monitoring system, or both time and date stamp the signal provided from the detector. As a result, the time and date of the card-in signal is recorded and this may be used to track and order events on the table. At a decision step 476, the table monitoring system, the smart shoe, or both, determine if the dealer hand forms blackjack. It is contemplated that use of a smart shoe enables the table monitoring system, the smart shoe, or both to have such knowledge.

If at decision step 476 it is determined that the dealer hand is not a blackjack, then the operation advances to step 478. At step 478, the dealer initiates the player decision round of the game. In this example embodiment, the player decision round comprises the round, after dealing of the cards, when the players may elect to receive additional cards or place double-down bets. The player decision round ends after the player's decisions regarding receipt of additional cards and the process of card dealing to the players is complete, i.e. just before the dealer may received cards based on the rules of play. For example, certain events may or may not occur during the player round, such as betting, or other events.

At a step 480, the dealer round begins and, at the beginning of the dealer round, the dealer removes the dealer card(s) from the card detector. As a result, at a step 482 the card detector generates and provides a card-out signal to the table monitoring system. By indicating that the dealer has remove the cards, the detectors provide an optionally time and date stamped card-out signal to the table monitoring system. This indicates the end of the player decision round and the beginning of a dealer round. In this embodiment, the dealer round comprises a round wherein the dealer may receive cards in accordance with the rules of play. This information may be useful to the table monitoring system. For example during the dealer round players may not alter amounts bet. After the dealer has received their cards from the shoe, the dealer may collect losing best, pay winning bets, and collect the player cards. At step 484 the dealer round portion of the game is complete. At step 486 the operation returns to step 404.

If, at decision step 476 the operation determines that the dealer hand forms a blackjack, i.e. an ace card and a ten value card, then the operation advances to step 488 wherein the table monitoring system, the smart shoe, or both indicated that the dealer has a blackjack. Alternatively, the table monitoring system, the smart shoe, or both by reveal the blackjack to the dealer, and the dealer may inform the players of the blackjack dealer hand.

Accordingly, at a step 490, the dealer collects all losing bets and compensates or pays the insurance bets. Then, at step 490, the operation returns to step 404.

Advantages

The advantages of the method and apparatus described herein are not limited to the following advantages. As can be appreciated, the method and apparatus described herein has numerous advantages over other hole card detectors in addition to numerous differences. One such advantage is that as compared to some hole card detectors which require a particular type of card or card marking, any type card may be utilized with this hold card detector. This eliminates the need to utilize an expensive proprietary playing card which may be available in limited quantities.

Another advantage over other card detectors is that in one embodiment of this detector, the output signals indicate whether a card is in the detector, or not in the detector. As a result, operation is simplified and does not slow or interfere with the flow of the game. Likewise, the cost of the device may be minimized if desired. Over thousands of gaming tables, the cost factor may be significant.

Yet another advantage of the card detector as described herein provides an output that, unlike other card detectors, signals the phase or status of the game. In this manner, the card detector may serve as or be considered a dealer hand status detector or a game phase indicator. By way of example, other card detectors do not output a signal that indicates the status of the dealers hand or the game phase, namely, by indicating that the dealer has received one or more of their cards and/or by indicating that the dealers has begun the dealer action phase of the game. The dealer round or phase may comprise any dealer activity that involves removal of the dealer cards from the card detector. In the exemplary game of blackjack, the dealer round occurs after the players received their cards during the player decision round. This provides an input to the table monitoring system regarding the phase of the game or status of the dealer's hand which is not available in other systems.

In addition, a date and time stamp, which is not offered by other hole card detectors, provides valuable data to be used to record and synchronize when events occur and/or synchronize events with other table rules, actions at the table, and other monitoring inputs.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. The elements described herein may be provided alone or combined in any combination.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A game status detector comprising:
a housing configured to accept one or more playing cards;
a signal generator configured to generate a detector signal which is directed into the housing;
a signal detector configured to:
detect the detector signal when a playing card is not within the housing; and
not detect the detector signal when the playing card is within the housing, the detector signal being blocked by the playing card;
generate a game status output representing whether a card is, or is not, within the housing; and
a radio frequency table monitoring system configured to receive and process the game status output to synchronize game status with data received from one or more radio frequency signal monitors associated with the table.

2. The detector of claim 1, further comprising a visual or audio indicator that will prompt the dealer the dealer that the dealer has a blackjack.

3. The detector of claim 1, wherein the game status output indicates the status of a game of blackjack.

4. The detector of claim 3, wherein the game status output differentiates between a player decision round and a dealer round during a game.

5. The detector of claim 1, wherein the detector signal comprise an optic signal.

6. The detector of claim 1, wherein the game status output is processed by the radio frequency table monitoring system to determine one or more of the following: start of a new game, end of dealing round, end of a betting round, or beginning of a dealer round.

7. A method for detecting one or more phases in a card game, the method comprising:
accepting one or more wagers;
dealing one or more cards to one or more players and dealing one or more cards to a dealer, wherein each card dealt to the dealer comprises a dealer card;
placing one or more dealer cards in a detector;
generating or eliminating a detector signal in response to one or more dealer cards being placed in the detector to thereby indicate a first phase of the game;
accepting one or more wagers from one or more players and dealing one or more cards to one or more players;
removing one or more dealer cards from the detector; and
generating or eliminating a second detector signal in response to one or more dealer cards being removed from the detector to thereby indicate a second phase of the game.

8. The method of claim 7, further comprising receiving the detector signal at a table monitoring system, wherein the table monitoring system is configured to monitor one or more wagers placed by one or more players, and one or more cards dealt to the one or more players, cards dealt to the dealer, or both.

9. The method of claim 8, wherein the table monitoring system comprises a radio frequency identification system configured to monitor one or more wagers using radio frequency signals.

10. The method of claim 8, further comprising processing the detector signal with the table monitoring system to differentiate between phases in the card game.

11. The method of claim 10, wherein the phases in the card comprise a player decision round and dealer round.

12. The method of claim 8, further comprising processing the detector signal with the table monitoring system to determine when wagering by the one or more players is not allowed.

13. The method of claim 7, wherein generating or eliminating a detector signal comprises actuating a mechanical switch which in turn generates the first detector signal or eliminates the first detector signal.

14. A game monitor for detecting and reporting one or more phases of a game to a wager monitoring system, the game monitor comprising:
a signal generator configured to generate a detector signal;
a detector configured to receive the detector signal and thereby detect one or more playing cards or a user input, and in response thereto, create a detector output;
an output path from the detector configured to convey the detector output to a wager monitoring system;
a wager monitoring system configured to receive and process the detector output to thereby record one or more phases of a game based on the detector output.

15. The monitor of claim 14, wherein the wager monitoring system is further configured with one or more radio frequency identification antennas which are configured to transmit and receive radio frequency signal.

16. The monitor of claim 14, wherein the detector comprises a playing card detector configured to receive one or more cards.

17. The monitor of claim 14, wherein the detector comprises a switch.

18. The monitor of claim 17, wherein the mechanical switch is actuated by a dealer or game operator.

19. The monitor of claim 14, wherein the signal generator comprises a signal generator selected from the group of signal generators consisting of a voltage or current signal generator, an optic signal generator, and electromagnetic signal generator.

20. The monitor of claim 19, further comprising a time stamp module configured to generator or associate a time stamp with the detector output.

21. The monitor of claim 14, wherein the detector output provides information regarding the rank of a card.
